(19) United States
(12) Patent Application Publication
(10) Pub. No.: US 2012/0218292 A1
(43) Pub. Date: Aug. 30, 2012

(54) SYSTEM AND METHOD FOR MULTISTAGE OPTIMIZED JPEG OUTPUT

(75) Inventor: Piotr Nyczyk, Krakow (PL)

(73) Assignee: nComputing Inc., Redwood City, CA (US)

(21) Appl. No.: 13/370,951

(22) Filed: Feb. 10, 2012

Related U.S. Application Data
(60) Provisional application No. 61/441,446, filed on Feb. 10, 2011.

(51) Int. Cl. G09G 5/00; G06T 1/00

(52) U.S. Cl. 345/629; 345/418

(57) ABSTRACT

A system and method for encoding graphical updates to a display screen of a remote device are disclosed in which regions of a display screen of a remote device that require updates are identified. Graphical updates of the display screen regions requiring updating are encoded as consecutive JPEG macroblocks. The encoded graphical updates are transmitted to the remote device with positioning metadata. The positioning metadata specifies locations of the JPEG macroblocks within the display screen of the remote device.

### CROSS-REFERENCE TO RELATED APPLICATIONS

This application claims priority under 35 U.S.C. §119 to U.S. Provisional Patent Application Ser. No. 61/441,446, filed Feb. 10, 2011, and entitled “SYSTEM AND METHOD FOR MULTISTAGE OPTIMIZED JPEG OUTPUT,” which application is incorporated herein by reference in its entirety.

### TECHNICAL FIELD

The present disclosure relates to the field of graphics processing. In particular, but not by way of limitation, the present disclosure discloses techniques for updating the graphics of remote devices.

### BACKGROUND

Centralized computer systems with multiple independent terminal systems for accessing the centralized computer systems were once the dominant computer system architecture. These centralized computer systems were initially very expensive mainframe or mini-computer systems that were shared by multiple computer users. Each of the computer system users accessed the centralized computer systems using a computer terminal system coupled to the centralized computer systems.

In the late 1970s and early 1980s, semiconductor microprocessors and memory devices allowed for the creation of inexpensive personal computer systems. Personal computer systems revolutionized the computing industry by allowing each individual computer user to have access to a full computer system without having to share the computer system with any other computer user. Each personal computer user could execute their own software applications and any problems with the computer system would only affect that single personal computer system user.

Although personal computer systems have become the dominant form of computing in the modern world, there has been a resurgence of the centralized computer system model wherein multiple computer users access a single server system using modern terminal systems that include high-resolution graphics. Computer terminal systems can significantly reduced computer system maintenance costs since computer terminal users cannot easily introduce computer viruses into the main computer system or load other unauthorized computer programs. Terminal based computing also allows multiple users to easily share the same set of software applications.

Modern personal computer systems have become increasingly powerful in the decades since the late 1970's personal computer revolution. Modern personal computer systems are now more powerful than the shared mainframe and mini-computer systems of the 1970's. In fact, modern personal computer systems are so powerful that the vast majority of the computing resources in modern personal computer systems generally sit idle when a typical computer user uses a modern personal computer system. Thus, personal computer systems can now easily serve multiple computer users.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 illustrates a diagrammatic representation of machine in the example form of a computer system within which a set of instructions, for causing the machine to perform any one or more of the methodologies discussed herein, may be executed.

FIG. 2A illustrates a high-level block diagram of an example single thin-client server computer system supporting multiple individual thin-client terminal systems using a local area network, according to some embodiments.

FIG. 2B illustrates a block diagram of an example thin-client terminal system coupled to a thin-client server computer system, according to some embodiments.

FIG. 2C illustrates a block diagram of an example thin-client terminal system coupled to a thin-client server computer system, according to some embodiments.

FIG. 3 illustrates a diagram of an encoding scheme for encoding non-contiguous display screen areas, according to some embodiments.

FIG. 4 illustrates a diagram of an encoding scheme for encoding pixel blocks of a color space into an encoded image of a different color space, according to some embodiments.

FIG. 5 illustrates a block diagram of an example thin-client terminal system coupled to a thin-client server computer system, according to some embodiments.

FIG. 6 illustrates a diagram in which regions of a display screen are encoded according to different encoding parameters, according to some embodiments.

FIG. 7 illustrates a flow diagram of an example method for encoding non-contiguous display screen areas, according to some embodiments.

FIG. 8 illustrates a flow diagram of an example method for encoding pixel blocks of a color space in an encoded image of a different color space, according to some embodiments.

FIG. 9 illustrates a flow diagram of an example method for encoding different regions of a display screen according to different encoding parameters, according to some embodiments.

### DETAILED DESCRIPTION

The following detailed description includes references to the accompanying drawings, which form a part of the detailed description. The drawings show illustrations in accordance with example embodiments. These embodiments, which are also referred to herein as “examples,” are described in enough detail to enable those skilled in the art to practice the invention. It will be apparent to one skilled in the art that specific details in the example embodiments are not required in order to practice the present invention. For example, although the example embodiments are mainly disclosed with reference to a thin-client system, the teachings of the present disclosure can be used in other environments wherein graphical update data is processed and transmitted. The example embodiments may be combined, other embodiments may be utilized, or structural, logical and electrical changes may be made without departing from the scope what is claimed. The following detailed description is, therefore, not to be taken in a limiting sense, and the scope is defined by the appended claims and their equivalents.

Computer Systems

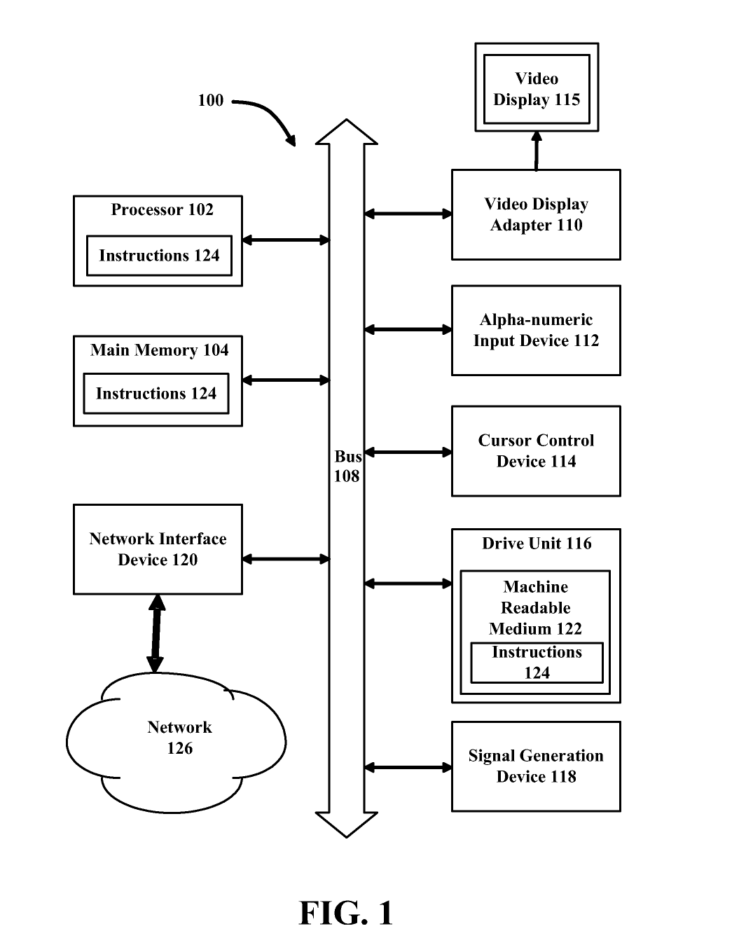

The present disclosure concerns computer systems. FIG. 1 illustrates a diagrammatic representation of machine in the example form of a computer system 100 that may be used to implement portions of the present disclosure. Within computer system 100 there are a set of instructions 124 that may be executed for causing the machine to perform any one or more of the operations discussed herein. In a networked deployment, the machine may operate in the capacity of a server machine or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of computer instructions (sequential or otherwise) that specify actions to be taken by that machine. Furthermore, while only a single machine is illustrated, the term “machine” shall also be taken to include any collection of machines that individually or jointly execute a set (or multiple sets) of instructions to perform any one or more of the operations discussed herein.

The example computer system 100 includes a processor 102 (e.g., a central processing unit (CPU), a graphics processing unit (GPU) or both), and a main memory 104 that communicate with each other via a bus 108. The computer system 100 may further include a video display adapter 110 that drives a video display system 115 such as a Liquid Crystal Display (LCD) or a Cathode Ray Tube (CRT). The computer system 100 also includes an alphanumeric input device 112 (e.g., a keyboard), a cursor control device 114 (e.g., a mouse or trackball), a disk drive unit 116, a signal generation device 118 (e.g., a speaker) and a network interface device 120.

The disk drive unit 116 includes a machine-readable medium 122 on which is stored one or more sets of computer instructions and data structures (e.g., instructions 124 also known as “software”) embodying or utilized by any one or more of the operations or functions described herein. The instructions 124 may also reside, completely or at least partially, within the main memory 104 and/or within the processor 102 during execution thereof by the computer system 100, the main memory 104 and the processor 102 also constituting machine-readable media.

The instructions 124 may further be transmitted or received over a computer network 126 via the network interface device 120. Such transmissions may occur utilizing any one of a number of well-known transfer protocols such as the well-known Transmission Control Protocol and Internet Protocol (TCP/IP), Internet Protocol Suite, or File Transport Protocol (FTP).

While the machine-readable medium 122 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies described herein, or that is capable of storing, encoding or carrying data structures utilized by or associated with such a set of instructions. The term “machine-readable medium” shall accordingly be taken to include, but not be limited to, solid-state memories, optical media, and magnetic media.

For the purposes of this specification, the term “module” includes an identifiable portion of code, computational or executable instructions, data, or computational object to achieve a particular function, operation, processing, or procedure. A module need not be implemented in software; a module may be implemented in software, hardware/circuitry, or a combination of software and hardware.

The Resurgence of Terminal Systems

Before the advent of the inexpensive personal computer, the computing industry largely used mainframe or mini-computers that were coupled to many “dumb” terminals. Such terminals are referred to as ‘dumb’ terminals since the computing ability resided within the mainframe or mini-computer and the terminal merely displayed an output and accepted alpha-numeric input. No user application programs executed on a processor within the terminal system. Computer operators shared the mainframe computer with multiple individual users that each used terminals coupled to the mainframe computer. These terminal systems generally had very limited graphic capabilities and were mostly visualizing only alpha-numeric characters on the display screen of the terminal.

With the introduction of the modern personal computer system, the use of dumb terminals and mainframe computer became much less popular since personal computer systems provided a much more cost effective solution. If the services of a dumb terminal were required to interface with a legacy terminal based computer system, a personal computer could easily execute a terminal emulation application that would allow the personal computer system to emulate the operations of a dumb terminal at a cost very similar to the cost of a dedicated dumb terminal.

During the personal computer revolution, personal computers introduced high resolution graphics to personal computer users. Such high-resolution graphics allowed for much more intuitive computer user interfaces than the traditional text-only display. For example, all modern personal computer operating systems provide user interfaces that use multiple different windows, icons, and pull-down menus that are implemented in high resolution graphics. Furthermore, high-resolution graphics allowed for applications that used photos, videos, and graphical images.

In recent years, a new generation of terminal systems have been introduced into the computer market as people have rediscovered some of the advantages of a terminal-based computer systems. For example, computer terminals allow for greater security and reduced maintenance costs since users of computer terminal systems cannot easily introduce computer viruses by downloading or installing new software. Only the main computer server system needs to be closely monitored in terminal-based computer systems. This new generation of computer terminal systems includes high-resolution graphics capabilities, audio output, and cursor control system (mouse, trackpad, trackball, etc.) input that personal computer users have become accustomed to. Thus, modern terminal systems are capable of providing the same features that personal computer system users have come to expect.

Modern terminal-based computer systems allow multiple users at individual high-resolution terminal systems to share a single personal computer system and all of the application software installed on that single personal computer system. In this manner, a modern high-resolution terminal system is capable of delivering nearly the full functionality of a personal computer system to each terminal system user without the cost and the maintenance requirements of an individual personal computer system for each user.

A category of these modern terminal systems is called “thin client” systems since the terminal systems are designed to be very simple and limited (thus “thin”) and depend upon the server system for application processing activities (thus it is a “client” of that server system). The thin-client terminal system thus mainly focuses only on conveying input from the user to the centralized server system and displaying output from the centralized server system to the terminal user. Note that although the techniques set forth this document will be disclosed with reference to thin-client terminal systems, the techniques described herein are applicable in other fields that process or transmit graphical updates to remote devices. For example, any system that needs to process and transmit graphical updates to remote devices may use the teachings disclosed in this document.

An Example Thin-Client System

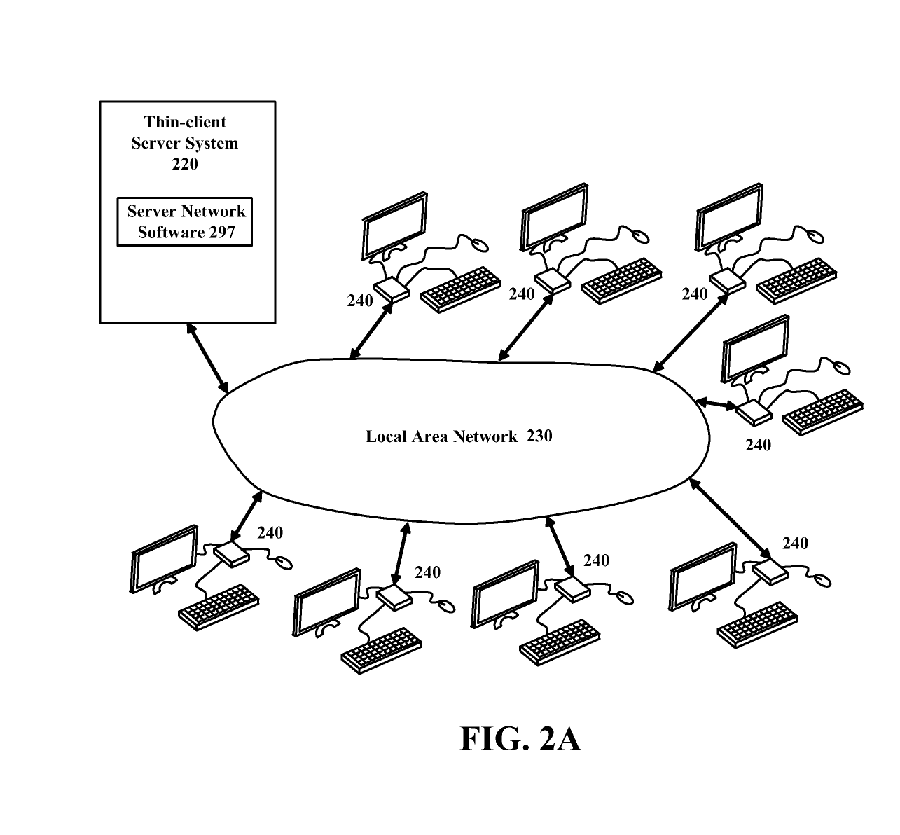

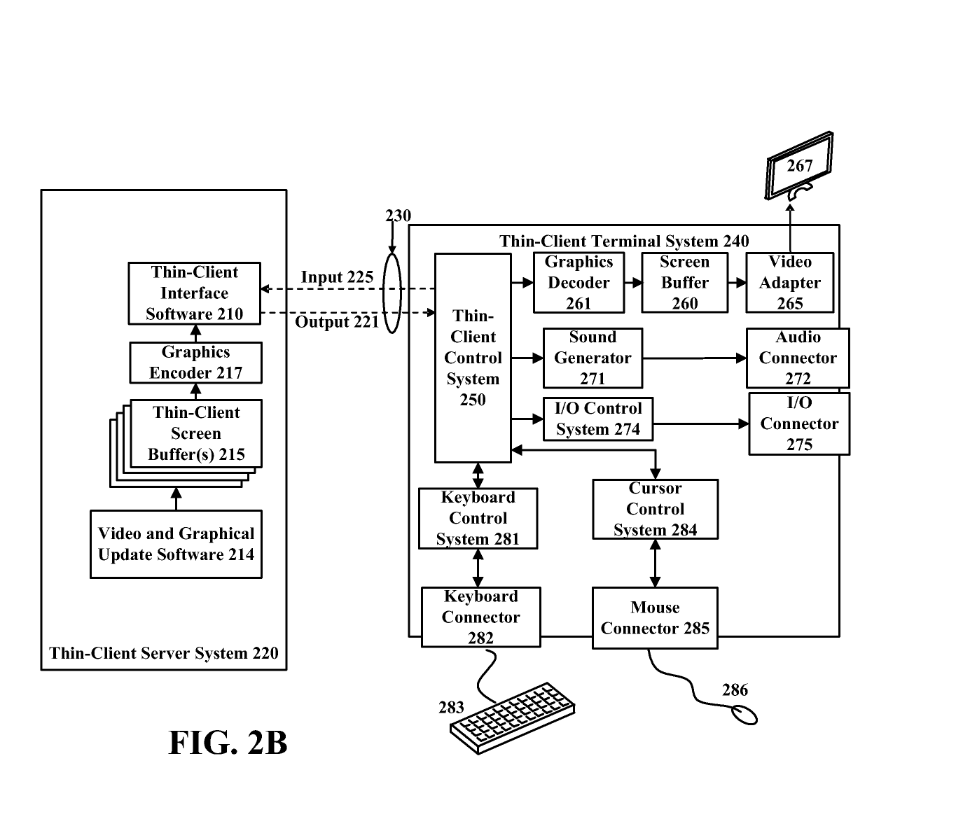

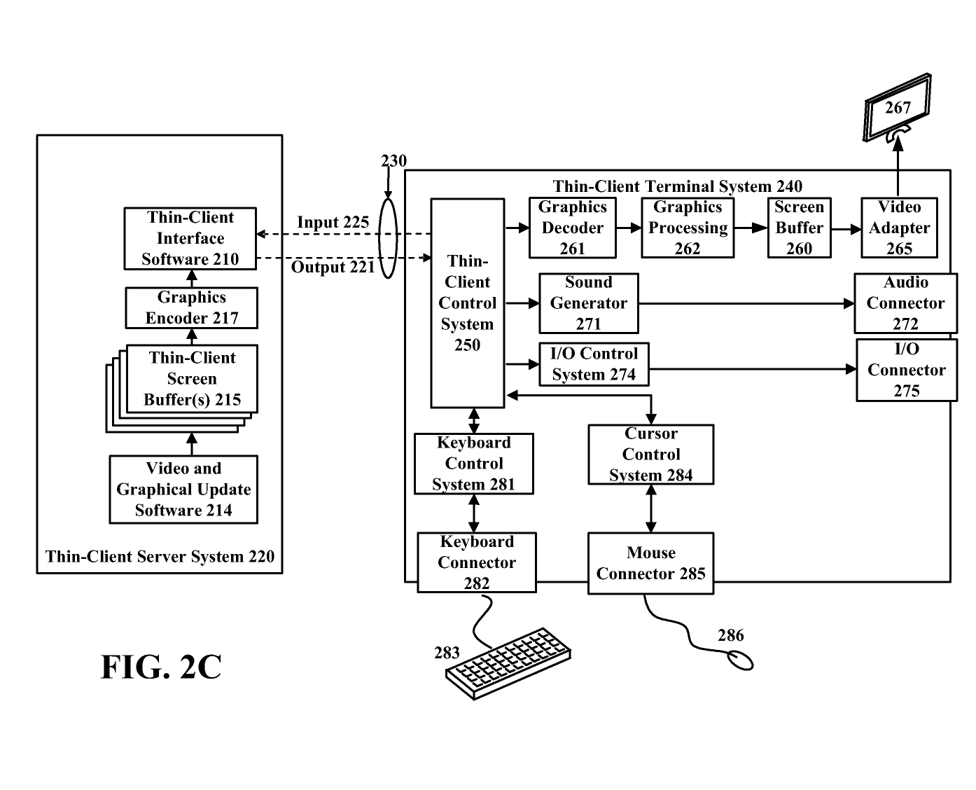

FIG. 2A illustrates a conceptual diagram of a thin-client environment. Referring to FIG. 2A, a single thin-client server computer system 220 provides computer processing resources to many thin-client terminal systems 240. In the embodiment of FIG. 2A, each of the individual thin-client terminal systems 240 is coupled to the thin-client server computer system 220 using local area network 230 as a bi-directional communication channel. The individual thin-client terminal systems 240 transmit user input (such as key strokes and mouse movements) across the local area network 230 to the thin-client server computer system 220 and the thin-client server computer system 220 transmits output information (such as video and audio) across the local area network 230 to the individual thin-client terminal systems 240. The individual thin-client terminal systems 240 are served using thin-client server network software 297 running on thin-client server computer system 220.

FIG. 2B illustrates a block diagram of an example embodiment of a thin-client server computer system 220 coupled to one (of possibly many) thin-client terminal system 240. The thin-client server computer system 220 and thin-client terminal system 240 each may include a network interface device that enables the two systems to be coupled with a bi-directional digital communications channel 230 that may be a serial data connection, an Ethernet connection, or any other suitable bi-directional digital communication means such as the local area network 230 of FIG. 2A.

The goal of thin-client terminal system 240 is to provide most or all of the standard input and output features of a personal computer system to the user of the thin-client terminal system 240. However, this goal should be achieved at the lowest possible cost since if a thin-client terminal system 240 is too expensive, a personal computer system could be purchased instead. Keeping the cost low can be achieved since the thin-client terminal system 240 will not need the full computing resources or software of a personal computer system since those features will be provided by the thin-client server computer system 220 that will interact with the thin-client terminal system 240.

Referring back to FIG. 2B, the thin-client terminal system 240 provides both visual and auditory output using a high-resolution video display system and an audio output system. The high-resolution video display system consists of a graphics update decoder 261, a screen buffer 260, and a video adapter 265. When changes are made to a representation of a terminal's display in thin-client screen buffer 215 within the thin-client server computer system 220, a graphics encoder 217 identifies those changes to the thin-client screen buffer 215, encodes the changes, and then transmits the changes to the thin-client terminal system 240. In an example embodiment, the graphics encoder 217 may be a Joint Photographic Experts Group (“JPEG”) encoder. Within the thin-client terminal system 240, the graphics update decoder 261 decodes graphical changes made to the associated thin-client screen buffer 215 in the thin-client server computer system 220 and applies those same changes to the local screen buffer 260, thus making screen buffer 260 an identical copy of the bit-mapped display information in thin-client screen buffer 215. In an example embodiment, the graphics update decoder 261 may be a JPEG decoder. Video adapter 265 reads the video display information out of screen buffer 260 and generates a video display signal to drive display system 267.

The audio sound system of thin-client terminal system 240 operates in a similar manner. The audio system consists of a sound generator 271 for creating a sound signal coupled to an audio connector 272. The sound generator 271 is supplied with audio information from thin-client control system 250 using audio information sent as output 221 by the thin-client server computer system 220 across bi-directional communications channel 230.

From an input perspective, thin-client terminal system 240 allows a terminal system user to enter both alpha-numeric (e.g., keyboard) input and cursor control device (e.g., mouse) input that will be transmitted to the thin-client server computer system 220. The alpha-numeric input is provided by a keyboard 283 coupled to a keyboard connector 282 that supplies signals to a keyboard control system 281. Thin-client control system 250 encodes keyboard input from the keyboard control system 281 and sends that keyboard input as input 225 to the thin-client server computer system 220. Similarly, the thin-client control system 250 encodes cursor control device input from cursor control system 284 and sends that cursor control input as input 225 to the thin-client server computer system 220. The cursor control input is received through a mouse connector 285 from a computer mouse 286 or any other suitable cursor control device such as a trackball or trackpad, among other things. The keyboard connector 282 and mouse connector 285 may be implemented with a PS/2 type of interface, a USB interface, or any other suitable interface.

The thin-client terminal system 240 may include other input, output, or combined input/output systems in order to provide additional functionality to the user of the thin-client terminal system 240. For example, the thin-client terminal system 240 illustrated in FIG. 2B includes input/output control system 274 coupled to input/output connector 275. Input/output control system 274 may be a Universal Serial Bus (USB) controller and input/output connector 275 may be a USB connector in order to provide USB capabilities to the user of thin-client terminal system 240.

Thin-client server computer system 220 is equipped with multi-tasking software for interacting with multiple thin-client terminal systems 240. As illustrated in FIG. 2B, thin-client interface software 210 in thin-client server computer system 220 supports the thin-client terminal system 240 as well as any other thin-client terminal systems coupled to thin-client server computer system 220. The thin-client server system 220 keeps track of the state of each thin-client terminal system 240 by maintaining a thin-client screen buffer 215 in the thin-client server computer system 220 for each thin-client terminal system 240. The thin-client screen buffer 215 in the thin-client server computer system 220 contains representation of what is displayed on the associated thin-client terminal system 240.

FIG. 2C illustrates a block diagram of an example embodiment of a thin-client server computer system 220 coupled to one (of possibly many) thin-client terminal system 240. The thin-client server computer system 220 and thin-client terminal system 240 are coupled with a bi-directional digital communications channel 230 that may be a serial data connection, an Ethernet connection, or any other suitable bi-directional digital communication means such as the local area network 230 of FIG. 2A.

Referring back to FIG. 2C, the thin-client terminal system 240 provides both visual and auditory output using a high-resolution video display system and an audio output system. The high-resolution video display system consists of a graphics update decoder 261, a graphics processing component 262, a screen buffer 260, and a video adapter 265. When changes are made to a representation of a terminal's display in thin-client screen buffer 215 within the thin-client server computer system 220, a graphics encoder 217 identifies those changes to the thin-client screen buffer 215, encodes the changes, and then transmits the changes to the thin-client terminal system 240. In an example embodiment, the graphics encoder 217 may be a JPEG encoder. As discussed further herein, the graphics encoder 217 may encode graphics updates to a remote display screen as blocks of Y′CbCr images encoded as a JPEG image, with accompanying metadata to instruct a graphics decoder on the positioning of the blocks on the remote display screen. In an example embodiment, the graphics encoder 217 may encode image blocks of a JPEG image in a RGB color space instead of a Y'CbCr color space. Such an encoding scheme may reduce the processing required to decode the graphical update at the remote device. In an example embodiment, the graphics encoder 217 may encode different individual screen blocks using different encoding parameters (e.g., compression ratio, color space). For example, the graphics encoder may encode certain image blocks in the Y'CbCr color space with a specified compression quality and other image blocks in a RGB color space with a specific compression quality. In an example embodiment, the different encoding schemes may be used to handle or differentiate between image blocks corresponding to fast changing areas of a display screen and static screen areas of a display screen.

Within the thin-client terminal system 240, the graphics update decoder 261 decodes graphical changes made to the associated thin-client screen buffer 215 in the thin-client server computer system 220. In an example embodiment, the graphics update decoder 261 may be a JPEG decoder. In certain example embodiments, a graphics processing component 262 may perform various image processing tasks, such as color space conversion (e.g., Y'CbCr to RGB) and the combining of image blocks of different encoding schemes (e.g., RGB image blocks and Y'CbCr image blocks). The graphics processing component 262 may comprise one or more processing components. For example, the graphics processing component 262 may include a separate color space converter. In an example embodiment, the graphics processing component 262 may include hardware or software components capable of implementing a YUV overlay. The results of the decoding and, in certain instances, processing of graphical updates may be applied to the local screen buffer 260, thus making screen buffer 260 an identical copy of the bit-mapped display information in thin-client screen buffer 215. Video adapter 265 reads the video display information out of screen buffer 260 and generates a video display signal to drive display system 267.

The audio sound system of thin-client terminal system 240 operates in a similar manner. The audio system consists of a sound generator 271 for creating a sound signal coupled to an audio connector 272. The sound generator 271 is supplied with audio information from thin-client control system 250 using audio information sent as output 221 by the thin-client server computer system 220 across bi-directional communications channel 230.

From an input perspective, thin-client terminal system 240 allows a terminal system user to enter both alpha-numeric (e.g., keyboard) input and cursor control device (e.g., mouse) input that will be transmitted to the thin-client server computer system 220. The alpha-numeric input is provided by a keyboard 283 coupled to a keyboard connector 282 that supplies signals to a keyboard control system 281. Thin-client control system 250 encodes keyboard input from the keyboard control system 281 and sends that keyboard input as input 225 to the thin-client server computer system 220. Similarly, the thin-client control system 250 encodes cursor control device input from cursor control system 284 and sends that cursor control input as input 225 to the thin-client server computer system 220. The cursor control input is received through a mouse connector 285 from a computer mouse 286 or any other suitable cursor control device such as a trackball or trackpad, among other things. The keyboard connector 282 and mouse connector 285 may be implemented with a PS/2 type of interface, a USB interface, or any other suitable interface.

The thin-client terminal system 240 may include other input, output, or combined input/output systems in order to provide additional functionality to the user of the thin-client terminal system 240. For example, the thin-client terminal system 240 illustrated in FIG. 2B includes input/output control system 274 coupled to input/output connector 275. Input/output control system 274 may be a Universal Serial Bus (USB) controller and input/output connector 275 may be a USB connector in order to provide USB capabilities to the user of thin-client terminal system 240.

Thin-client server computer system 220 is equipped with multi-tasking software for interacting with multiple thin-client terminal systems 240. As illustrated in FIG. 2B, thin-client interface software 210 in thin-client server computer system 220 supports the thin-client terminal system 240 as well as any other thin-client terminal systems coupled to thin-client server computer system 220. The thin-client server system 220 keeps track of the state of each thin-client terminal system 240 by maintaining a thin-client screen buffer 215 in the thin-client server computer system 220 for each thin-client terminal system 240. The thin-client screen buffer 215 in the thin-client server computer system 220 contains representation of what is displayed on the associated thin-client terminal system 240.

Currently, there are a number of remote computer desktop access protocol and methods, which in general can be divided into the two groups, graphics-based functions and frame buffer area updates. Graphics-based functions, used by remote desktop software protocols such as the Remote Desktop Protocol for Microsoft Windows Terminal Server, X11 for the Unix and Linux operating systems, and NX, an application that handles X Windows Systems, typically transmit all of the graphics functions that would normally be performed on a local display, such as drawing lines, polygons, filling areas, and text output, over the network to a remote device for re-execution at the remote device to create a remote desktop image. Frame buffer areas updates, used by remote desktop software protocols such as Virtual Networking Computing (VNC), which uses the Remote Frame Buffer (RFB) protocol, and the UXP protocol developed by NComputing, typically perform the graphics functions locally on a virtual frame buffer represented as part of local system's memory, with updated screen regions being transmitted periodically to a remote device as image data. Some of the remote desktop protocol implementations may use methods from both groups, while still being classified as belonging to one family considering the major methods used.

With respect to frame buffer-based remote desktop transmission, a source of graphical updates (e.g., a server) may send rectangular images representing updated areas of a desktop screen of a remote device. In some embodiments, the size of the updated regions may differ. For example, fixed size rectangles or squares aligned to a regular grid, or variable sized rectangles may be used. In some embodiments, the individual images representing updated areas of the desktop screen may be encoded differently. For example, the images may be transmitted as raw image data or as compressed image data using various compression methods such as palette compression, run-length encoding (RLE) or other types of data compression.

As will be discussed in further detail herein, example embodiments relating to the Multistage Optimized Jpeg Output (MOJO) may relate to frame buffer-based methods of transmitting a computer desktop screen to the remote device.

JPEG Image Structure

During a typical JPEG encoding process, RGB image data which is displayed on screen is transformed into an Y'CbCr planar image. This results in three individual planes corresponding to a luma or brightness component (Y), a blue-difference chroma component (Cb), and a red-difference chroma component (Cr). The planes may be compressed independently using Discrete Cosine Transformation (DCT). In some embodiments, the chroma or color difference planes may be downsampled according to one of several ratios. The ratios are commonly expressed in three parts in the format J:a:b, where J refers to a width of the region being compressed (in pixels), a refers to a number of chrominance samples in a first row of J pixels, and b refers to a number of chrominance samples in a second row of J pixels. Commonly used ratio include 4:4:4, in which every image pixel has its chrominance value included, 4:2:2, in which the chrominance of the image pixels is reduced by a factor of 2 in the horizontal direction, and 4:2:0, in which the chrominance of the image pixels is reduced by a factor of 2 in both the horizontal and vertical directions.

After downsampling, each image plane is divided into 8×8 pixel blocks, and each of the blocks is compressed using discrete cosine transform (DCT). Depending on the chroma downsampling, the compressed pixel block (also referred to as a Minimal Coded Unit (MCU)) may have a block size of 8×8 for a 4:4:4 ratio (i.e., no downsampling), 16×8 for a 4:2:2 downsampling ratio, or 16×16 for a 4:2:0 downsampling ratio. The MCU may be referred to as a macroblock. For a 16×16 macroblock, this means that the smallest image unit is a 16×16 pixel block, which contains 4 blocks of luma plane, 1 block of Cb, and 1 block of Cr, each of them being an 8×8 pixel square.

One downside of the JPEG standard is that it does not allow the encoding of transparency information or sparse images, namely images with empty areas. Consequently, it is not very suitable for sending random screen areas updates. Instead, the JPEG standard is more suited to sending single rectangular image areas.

Example embodiments disclosed herein provide a remote frame buffer update encoding technique called Multistage Optimized JPEG Output (MOJO), which uses JPEG compression for fixed size screen blocks by utilizing a standard JPEG compressor and decompressor, which may be either software or hardware accelerated. MOJO enriches the high compression ratio achieved by JPEG with a possibility to encode, transmit, and decode sparse image areas as a single JPEG image with additional metadata.

In addition, MOJO introduces a multistage output, where fast changing regions of a screen, corresponding to such things as video or animation, can be transmitted and displayed on the remote device at a lower resolution and/or higher compression rate. Video overlay hardware also may be employed to display fast changing regions of the screen on the remote device display. The low-quality areas corresponding to fast changing regions of the screen are combined with high-quality encoded static parts of the screen in one desktop screen image. In some embodiments, MOJO may run efficiently on small and low-performance embedded systems like thin clients.

JPEG with Command List

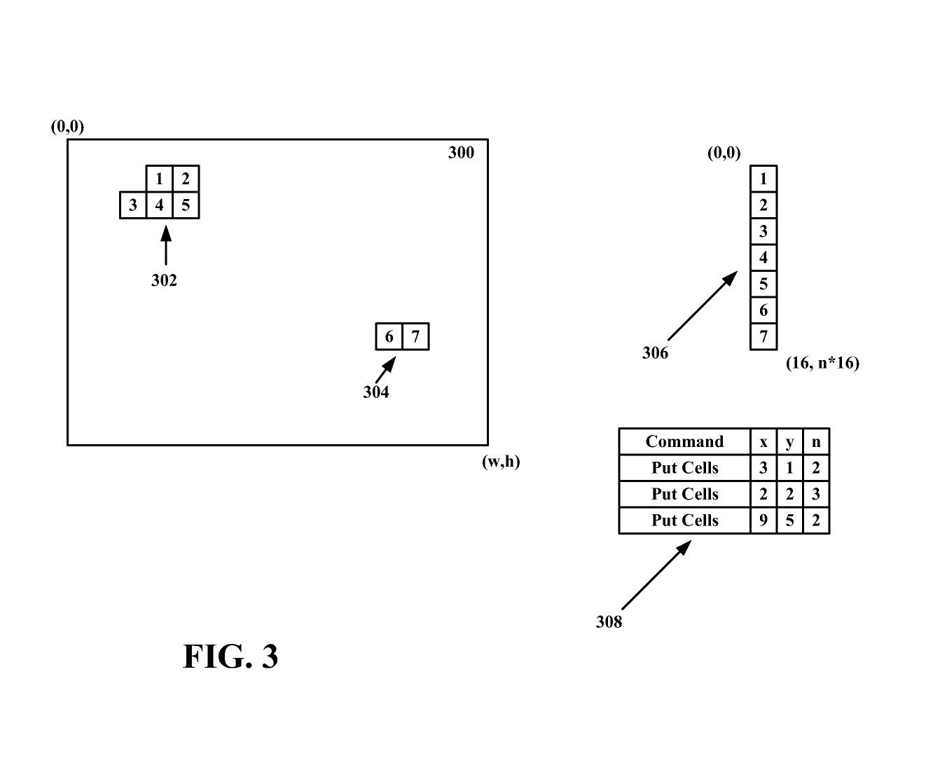

As discussed above, a JPEG image file typically is a single rectangular image. In some embodiments, randomly distributed desktop areas requiring graphical updates may be encoded within a JPEG file despite the fact that the JPEG file contains a uniform rectangular image area without any “holes.” FIG. 3 illustrates an example embodiment of a display screen having randomly distributed areas requiring graphical updates. For example, the regions 302 and 304 of a display screen 300 with a width of w pixels and a height of h pixels may be areas requiring graphical updates. Assuming a downsampling ratio of 4:2:0 such that the MCUs are 16×16 macroblocks, each of the pixel blocks 1 through 7 illustrated in FIG. 3 may be 16×16 macroblocks. A graphics encoder, such as the graphics encoder 217 of FIGS. 2B and 2C, may be a JPEG encoder (and either hardware or software accelerated) that compresses each 16×16 pixel macroblock independently using DCT. The encoder 217 may pack randomly distributed screen updates in consecutive 16×16 blocks of a JPEG image 306 and send the blocks with additional metadata 308 that instructs a graphics decoder, such as the graphics decoder 261 of FIGS. 2B and 2C, on how to position the blocks on the remote screen.

In the example embodiment of FIG. 3, there are seven blocks updated on screen in three continuous horizontal spans. As a result, an image 306 of 16×112 pixels is created and compressed. The image contains exactly 7 blocks of 16×16 pixels each in a vertical layout. The additional metadata 308 that facilitates decoding of the resulting JPEG image and placement of the macroblocks in their destination positions may take the form of a command list. In some embodiments, the metadata 308 may specify coordinates within the display screen area for placing the macroblocks along with a number of macroblocks to be placed at the coordinates. For example, the first row of the command list may specify that the first 2 macroblocks (corresponding to n=2) of the packed JPEG image 306 should be placed beginning at the coordinates x=3 and y=1 (i.e., on the second row of the display screen area and as the fourth pixel of the row) of the display screen. The second row of the command list 308 may specify that the next 3 macroblocks of the JPEG image should be placed at the coordinates x=2, y=2. The third row of the command list 308 may specify that the last 2 macroblocks of the JPEG image should be placed beginning at the coordinates x=9, y=5.

The above example illustrates how additional metadata enables JPEG encoding to be utilized for the compression of non-contiguous desktop areas. This mode of operation does not introduce any additional compression artifacts, as the DCT algorithm operates only within 16×16 pixel block, and does not “look” behind the border.

Shuffled Planar RGB

In some embodiments, the internal JPEG image structure is not very suitable to be displayed directly in a RGB frame buffer on low performance hardware due to the encoded image consisting of individual picture blocks which are planar Y'CbCr images rather than RGB images. Additionally, the conversion of Y'CbCr data to RGB data may be slow. Although Y'CbCr is the internal color space of JPEG images, in some embodiments, the internal color space of the JPEG image may be changed to use the RGB color model directly due to the fact that JPEG compression algorithm is processing the image data block by block and plane by plane.

In addition, a commonly used JPEG format is 4:2:0 downsampling, in which the Cb and Cr planes are assumed to be downscaled by a factor of 2 along the X and Y axes. Under this format, for each block of 16×16 pixels in the source image, there may be six blocks of 8×8 pixels written in the JPEG file, consisting of four blocks for the full resolution luminosity plane, one block for the Cb plane, and one block for the Cr plane. However, taking into account that the JPEG decompression pipeline outputs individual 8×8 pixel blocks sequentially, it is possible to work around this limitation and transmit planar RGB data by encoding a specially crafted JPEG image. This technique is referred to herein as Shuffled Planar RGB (SPRGB) color space.

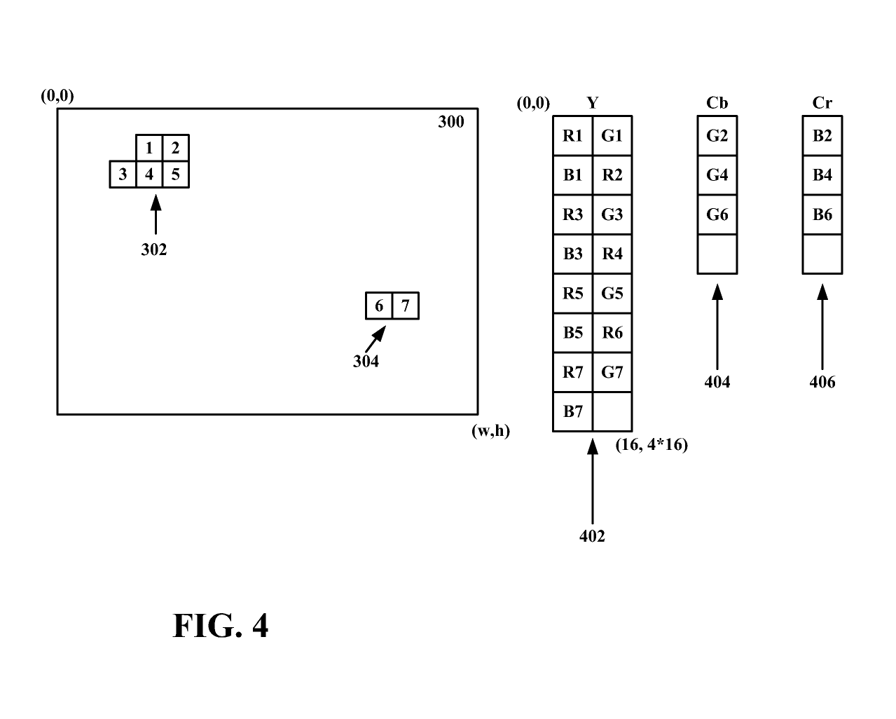

To encode one block of 8×8 pixels in RGB color space, three blocks of 8×8 pixels corresponding to one block for each color plane (e.g., red color plane, green color plane, and blue color plane) are encoded. This means that in a single 16×16 pixel block (e.g., six 8×8 pixel blocks using a 4:2:0 JPEG format) of a standard Y'CbCr JPEG image, two SPRGB blocks of 8×8 pixels may be packed. FIG. 4 illustrates an example diagram of packing two SPRGB blocks into a 16×16 pixel macroblock of a standard Y'CbCr JPEG image. In the example embodiment of FIG. 4, there are seven updated RGB blocks, denoted by the numbers 1 through 7 and in the pixel groups 302 and 304. The seven RGB blocks do not fully fill four JPEG blocks of 16×16 pixels. In some embodiments, unused portion of the JPEG 16×16 blocks may be filled with a black color (or any solid color).

Y'CbCr to RGB color space

In some embodiments, a Y'CbCr to RGB color space (YCbCr2RGB) may be created to improve compression ratio. Instead of packing sophisticated RGB planes encoded of SPRGB pixel blocks in a single JPEG image, 16×16 pixel cells encoded in a Y'CbCr 4:2:0 color space natively may be used. Then, at the remote device, the cells may be converted to RGB color space and placed into the RGB frame buffer according to metadata, such as the MOJO command list 308 of FIG. 3. This mode of operation has one big advantage, which is better compression ratio (thanks to the chroma subsampling), and several drawbacks, including the need of a software Y'CbCr to RGB conversion which may require numerous CPU cycles, the use of increased cell sizes (e.g., 16×16) which may not be optimal for updates of small or narrow areas such as single letters typed into text window, horizontal or vertical lines that result in at least 16 pixel high/wide rectangle to be drawn, and so forth, and the generation of additional artifacts caused by chroma subsampling during the display of text or very narrow lines.

Multistage Output

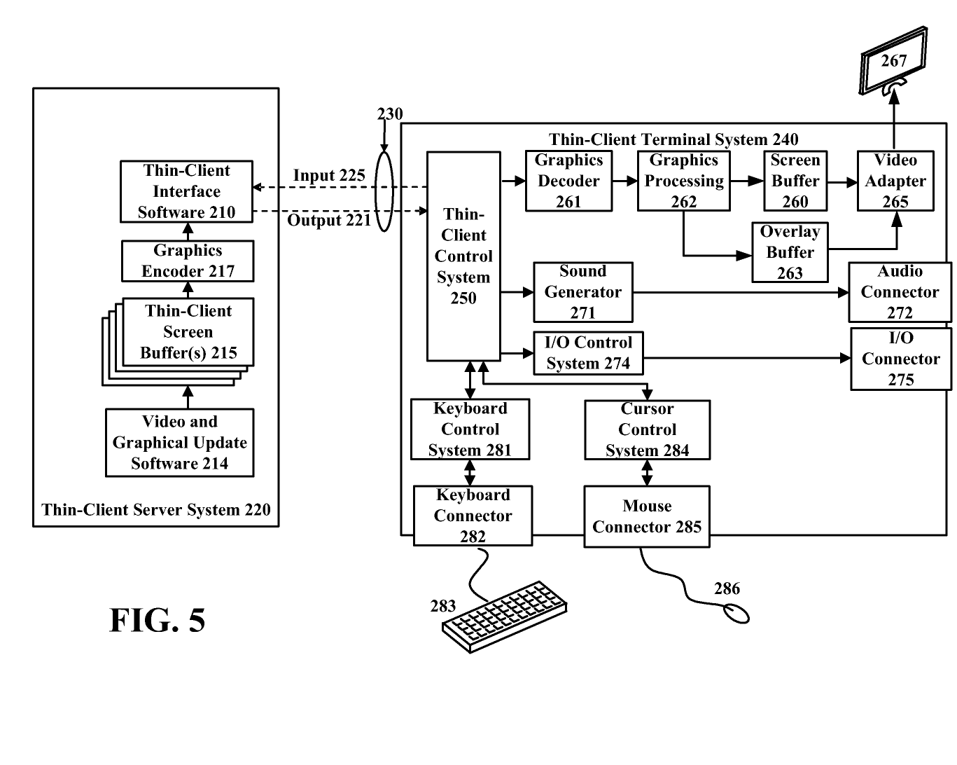

To achieve an even better compression ratio and responsiveness for fast changing screen areas (e.g., video streaming, flash animation, animated 2D and 3D graphics), in some embodiments, a semi-progressive image delivery may be employed. FIG. 5 illustrates a block diagram of an example thin-client terminal system coupled to a thin-client server computer system that is configured to enable the semi-progressive image delivery, according to some embodiments. The thin-client terminal system 220 may include a graphics encoder 217 configured to encode pixels at varying JPEG compression qualities. The graphics encoder 217 also may be configured to encode pixels according to one of a plurality of color spaces.

The graphics encoder 217 may encode individual screen blocks using different encoding parameters such as JPEG quality (e.g., compression ratio) and color space. The individual screen blocks may then be transmitted to the remote device. In some embodiments, two types of pixel blocks, also called stages, may be used. A Stage 1 block may be a block of pixels in the Y'CbCr color space with default JPEG quality (e.g., 85 out of 100). Stage 1 blocks may be used to encode display screen regions containing fast changing areas. A Stage 2 block may be a SPRGB block of pixels with default JPEG quality (e.g., 85 out of 100). Stage 2 blocks may be used for static screen areas. It is noted that a single 16×16 block compressed in Y'CbCr color space may take approximately the same amount of memory as two blocks of 8×8 pixels encoded in SPRGB color space.

In some embodiments, a single block size for a Stage 1 block in the Y'CbCr color space may be 16×16 pixels rather than 8×8 pixels, which means that each Stage 1 block corresponds to four Stage 2 blocks. In some embodiments, the Stage 1 block may be scaled horizontally by a factor of two to achieve an even better compression rate, thereby turning a single 16×16 Stage 1 block into a 32×16 block, which corresponds to eight Stage 2 blocks. By horizontally scaling the Y'CbCr color space, a single 32×16 block encoded in horizontally downscaled 16×16 Y'CbCr block may take approximately about four times less memory (bandwidth) than the SPRGB equivalent (e.g., eight SPRGB blocks of 8×8 pixels).

At a remote device, such as the thin-client terminal system 240 of FIG. 5, a YUV overlay technique may be used to improve performance, provided the appropriate hardware is available. The thin-client terminal system 240 of FIG. 5 may differ from the thin-client terminal systems of FIGS. 2B and 2C through the inclusion of an overlay buffer 261. An overlay technique is usually used for video display, and typically is based on a key color masking technique, where the final display signal is composed from the base RGB frame buffer and YUV overlay buffer for the areas masked by the key color. For purposes of the multistage output, an additional color space YCBCR may be created. YCBCR may be conceptually different than YCBCR2RGB color space previously discussed herein, in that the image data is not placed directly in the RGB frame buffer, but rather in the overlay buffer 261 of the thin-client terminal system 240.

In some embodiments, the MOJO multistage output blocks may be combined with SPRGB blocks at the same time on screen, meaning that if YUV overlay is in use, it has to remain active all the time, and it has to be configured to show a single full screen Y'CbCr image. Through the use of key color masking, each block may be displayed individually as either a Stage 1 block (e.g., an 8×8 pixel block in RGB frame buffer) or a Stage 2 block (e.g., a 16×16 pixel block in the YUV buffer). The Stage 2 block may be scaled horizontally by factor of two by a scaler (not shown), and may include a number of blue 8×8 blocks equal to the corresponding places of the RGB frame buffer 260.

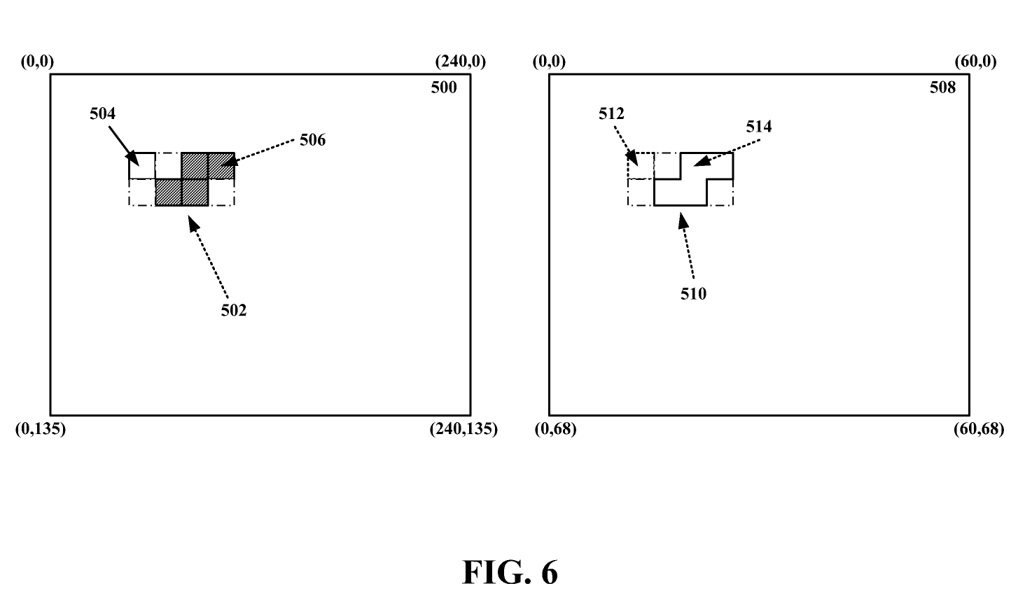

In some embodiments, if a 32×16 rectangle is displayed as a Stage 1 block, portions of the 32×16 block may be displayed in worse quality with the granularity of an 8×8 block. Referring to FIG. 6, a diagram in which regions of a display screen are encoded according to different encoding parameters is shown, according to some embodiments. In the example embodiment of FIG. 6, an RGB buffer 500 is shown containing a 16×16 YUV pixel block rectangle 502. The 16×16 YUV pixel block rectangle 502 may include an 8×8 pixel Stage 2 block 504. The Stage 2 block 504 may be an RGB or SPRGB 8×8 block of pixels. A plurality of 8×8 pixel blocks 506 may represent lower quality portions of the decoded JPEG image. These blocks 506 may correspond to a fast changing area of the display screen. In some embodiments, the blocks 506 may be represented by a key color that indicates to the thin-client terminal system 240 that image data for these blocks 506 should be read from a YUV buffer 508. In the YUV buffer, the 32×16 rectangle may include pixel blocks 514 that correspond to the pixel blocks 506 represented in the RGB buffer 500 by key color masking In some embodiments, when a display signal is read from the buffers 500, 508 by the video adapter 265, image data may be retrieved from the RGB buffer 500. The presence of key color masking in the image data retrieved from the RGB buffer 500 may indicate that image data should also be retrieved from the YUV buffer 508. YUV buffer image data corresponding to key color regions of the RGB buffer image data may be retrieved and combined with the RGB buffer image data to form a display signal.

In some embodiments, there may be a significant SPRGB to Y'CbCr switching cost, which is a necessity to draw key blocks in the RGB frame buffer every time a Y'CbCr block is to be displayed in the position which was previously displayed in RGB mode. Switching the color space for individual block updates may degrade the overall performance of the decoder in comparison to a situation when only Stage 2 blocks are used. The performance degradation may be offset by using a detection algorithm to determine fast changing areas of a remote device display screen on the server side, and to use Stage 1 blocks only for generally static images or long lasting animations.

Accordingly, the example embodiments described herein may significantly improve performance of frame buffer-based remote desktop delivery even on low-performance access devices. For example, using a standard JPEG image file format and the standard compressor (e.g., graphics encoder 217) and decompressor (e.g., graphics decoder 261) (either software or hardware) with an attached binary encoded command list (metadata) which specifies how the consecutive JPEG macroblocks should be positioned on the image receiver side (remote frame buffer in case of remote desktop protocol), the accurate restitution of the partial image may be accomplished. The partial image is otherwise impossible to compress with a JPEG compression algorithm. In another example, planar RGB image blocks (8×8 pixels) may be encoded and transmitted via typical Y'CbCr 4:2:0 macro blocks, by encoding two planar RGB blocks in one Y'CbCr 4:2:0 macro block. This method of image data encoding allows the use of even very basic JPEG decompressors (namely such decompressors which support only the Y'CbCr 4:2:0 JPEG image format) with very low CPU overhead for presentation in RGB frame buffer. In another example, encoding and transmitting different parts of screen may be accomplished using different JPEG quality and color spaces. In another example, YUV overlay, which was originally designed for video display, may be used to present a single desktop screen with regions of different image quality at the same time.

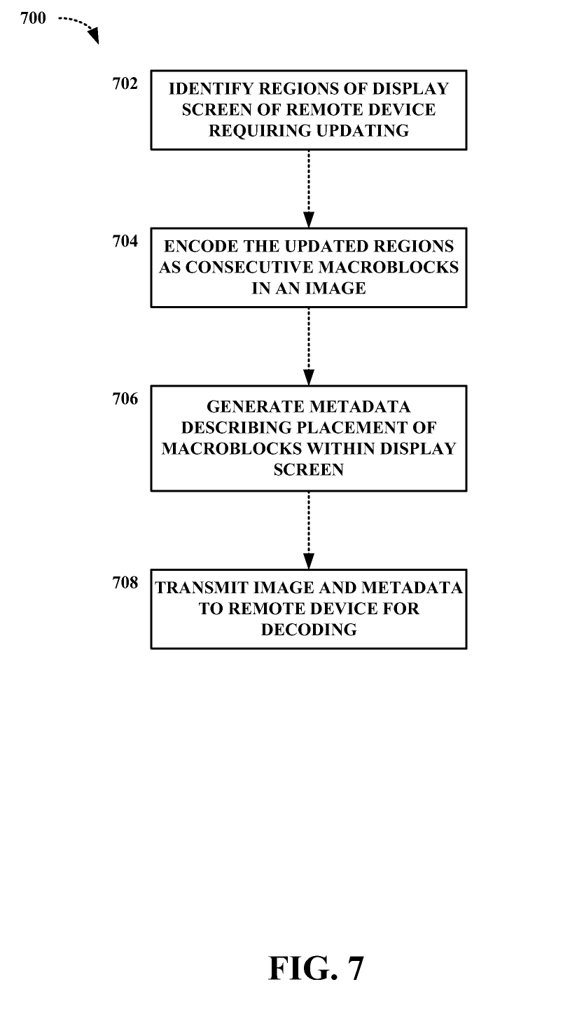

FIG. 7 illustrates a flow diagram of an example method for encoding non-contiguous or partial display screen areas, according to some embodiments. At block 702, regions of a display screen of a remote device that require updating may be identified. The identification may be performed by a server that transmits graphical updates to the remote device. In some embodiments, the server and the remote device may comprise a thin-client computing environment, where the remote device is a thin-client terminal system and the server is a thin-client server system. In some embodiments, the regions of the display screen requiring updating may be located in disparate or non-contiguous areas of the display screen.

At block 704, a graphics encoder may encode the updated regions as consecutive macroblocks in an image. In some embodiments, the image may be a JPEG image, and the graphics encoder may be a JPEG compressor. The macroblocks may be of a predetermined pixel size, such as 8×8 or 16×16 pixel blocks. In some embodiments, the macroblocks may be packed into the image consecutively.

At block 706, the graphics encoder or a processor may generate metadata describing the placement of the macroblocks within the display screen. In some embodiments, the metadata may take the form of a command list. In some embodiments, the metadata may specify the coordinates within the display area of the macroblocks. In some embodiments, the metadata may specify an initial coordinate for placement of the macroblocks within the display area as well as the number of macroblocks to be placed consecutively beginning at the specified initial coordinates. In some embodiments, the coordinates may be expressed in terms of pixels.

At block 708, the generated metadata may be appended to the image. The metadata and the image may be transmitted to the remote device, where a controller and a graphics decoder may process the metadata and decode the image using the metadata. The decoded image data may be placed in a buffer located in the remote device.

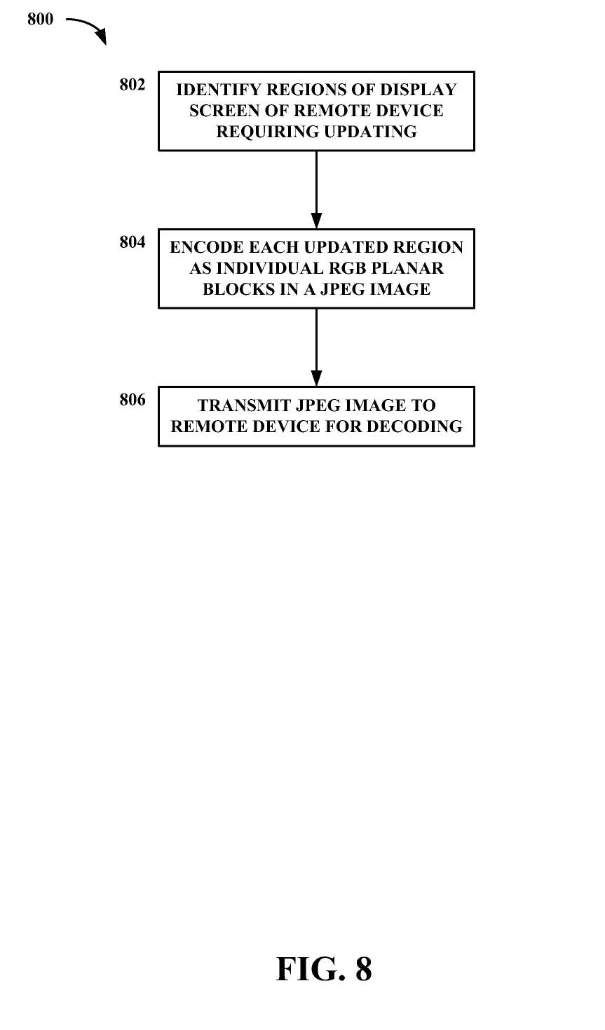

FIG. 8 illustrates a flow diagram of an example method for encoding pixel blocks of a color space in an encoded image of a different color space, according to some embodiments. At block 802, regions of a display screen of a remote device that require updating may be identified. The identification may be performed by a server that transmits graphical updates to the remote device. In some embodiments, the server and the remote device may comprise a thin-client computing environment, where the remote device is a thin-client terminal system and the server is a thin-client server system. In some embodiments, the regions of the display screen requiring updating may be located in disparate or non-contiguous areas of the display screen.

At block 804, the regions requiring updating may be encoded within an image of a first color space. For example, the image may be a JPEG image where JPEG image data is encoded as individual planar images in the Y'CbCr color space. In some embodiments, the JPEG image may be of a format that uses 4:2:0 downsampling, where the Cb and Cr planes are downscaled by a factor of two along the X and Y axes. In some embodiments, for a 16×16 macroblock of pixels in a source image, a JPEG image having a 4:2:0 format may contain six corresponding 8×8 blocks of pixels (corresponding to four blocks of luma plane, one block of Cb, and one block of Cr) in the image.

In some embodiments, taking advantage of the fact that the JPEG decompression pipeline outputs individual 8×8 pixel blocks sequentially, a graphics encoder may encode 8×8 blocks in the RGB color space within the internal image structure of the JPEG image. The graphics encoder may encode a block of 8×8 pixels in the RGB color space by encoding three blocks of 8×8 pixels corresponding to each color plane of the RGB color space. The encoded 8×8 pixel block color planes may be packed in the JPEG image. To the extent pixel blocks in the JPEG image are not packed with RBG image data, in some embodiments, a predetermined color may be used to fill those blocks. In some embodiments, the controller and/or decoder of the thin-client terminal system may be instructed to ignore blocks containing the predetermined color.

At block 806, the JPEG image may be transmitted to the remote device, where a graphics decode may decode the image data from the JPEG image and draw the image data in a frame buffer.

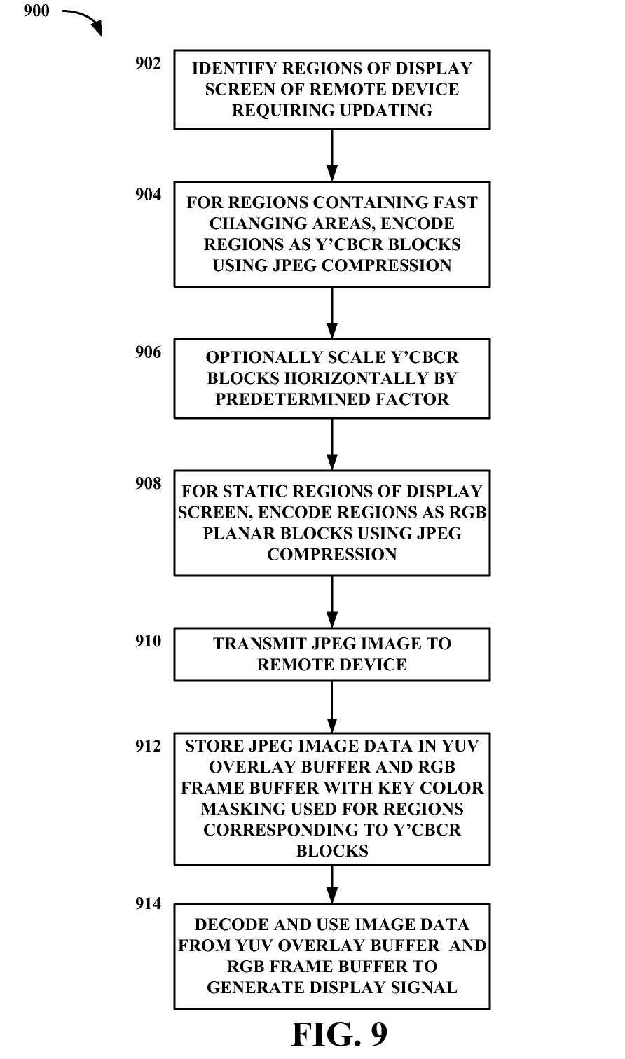

FIG. 9 illustrates a flow diagram of an example method for encoding different regions of a display screen according to different encoding parameters, according to some embodiments. At block 902, regions of a display screen of a remote device that require updating may be identified. The regions may include regions containing fast changing areas, such as videos, flash animations, or 2D or 3D animations. The regions also may include relatively static regions that require updating. The identification may be performed by a server that transmits graphical updates to the remote device. In some embodiments, the server and the remote device may comprise a thin-client computing environment, where the remote device is a thin-client terminal system and the server is a thin-client server system. In some embodiments, the regions of the display screen requiring updating may be located in disparate or non-contiguous areas of the display screen.

At block 904, the server, via a graphics encoder, may encode regions containing fast changing areas as pixel blocks in a JPEG image. The pixel blocks may be encoded in the Y'CbCr color space. The graphics encoder may encode the pixel blocks according to a predetermined compression quality on a scale of 0 to 100, where 100 indicates the highest quality. In some embodiments, the regions being encoded may be encoded as 16×16 pixel blocks.

At block 906, the compression of the 16×16 Y'CbCr block may be improved by scaling the Y'CbCr block horizontally by a factor of two, thus yielding a 32×16 block. In some embodiments, the compression of the 16×16 Y'CbCr block may be optional.

At block 908, relatively static regions of the display area that require updating may be encoded by the graphics encoder as RGB planar blocks (e.g., SPRGB blocks). For an 8×8 pixel block, three 8×8 pixel blocks corresponding to each of color component of the RGB color space may be encoded and packed within the internal JPEG image structure. In some embodiments, metadata may be generated and appended to the JPEG image to instruction a decoder as to the placement of the RGB planar blocks within the display area.

At block 910, the JPEG image containing the Y'CbCr blocks corresponding to fast changing areas and the RGB planar blocks corresponding to relatively static areas may be transmitted to a remote device, such as a thin-client terminal system.

At block 912, the JPEG image may be processed and decoded by a graphics decoder. JPEG image data corresponding to fast changing areas may be stored in a YUV overlay buffer, while RGB planar image data may be drawn in the RGB frame buffer. Image data corresponding to the Y'CbCr blocks may be represented in the RGB frame buffer using key color masking

At block 914, a display signal is generated by reading the RGB and YUV buffers and combining the contents of the buffer. The presence of the key color masking in the RGB buffer may instruct a video adapter to retrieve and use image data from the YUV buffer in place of the key color masking

It is contemplated that a server, such as the thin-client server system of FIGS. 2B, 2C, and 5 may include one or more processors and one or more encoders configured to encode graphics updates for a display screen for a remote device according to one or more of the example embodiments described herein, including the example methods disclosed in FIGS. 7-9. In some embodiments, the encoders may be hardware accelerated by the one or more processors (e.g., CPUs , graphics processing units (GPUs), graphics cards, graphics accelerators, floating-point accelerators, video cards)). In some embodiments, the encoders may be software accelerated. Further, in some embodiments, the server may be multi-modal such that the server may operate in one or more encoding modes (e.g., modes corresponding to the example embodiments of FIGS. 3-6 and corresponding discussion). In some embodiments, depending on one or more of the type of graphics updates, the available bandwidth of a communications channel between the server and the remote device, and the amount of updates being sent to one remote device or different remote devices to be performed, the thin-client server system may select a particular encoding mode and encode graphics updates according to the mode. Similarly, a remote device, such as a thin-client terminal system may include a processor, controller, or other logic (e.g., thin-client control system 250) capable of processing graphics updates received from the server. Upon receiving a graphics update from the server, the remote device may process the graphics server and detect the encoding scheme used to encode the graphics update. In some embodiments, the graphics decoder may be instructed as to the encoding scheme used (e.g., by the server, by received metadata accompanying the device) so that the graphics decoder may properly decode the graphics update.

The preceding technical disclosure is intended to be illustrative, and not restrictive. For example, the above-described embodiments (or one or more aspects thereof) may be used in combination with each other. Other embodiments will be apparent to those of skill in the art upon reviewing the above description. The scope of the claims should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

In this document, the terms “a” or “an” are used, as is common in patent documents, to include one or more than one. In this document, the term “or” is used to refer to a nonexclusive or, such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The Abstract is provided to comply with 37 C.F.R. §1.72(b), which requires that it allow the reader to quickly ascertain the nature of the technical disclosure. The abstract is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment.

What is claimed is:

1. A method of encoding graphical updates to a display screen of a remote device, the method comprising:
identifying regions of a display screen of a remote device requiring updating;
encoding graphical updates of the display screen regions requiring updating as consecutive JPEG macroblocks; and
transmitting the encoded graphical updates and positioning metadata to the remote device, the positioning metadata specifying locations of the JPEG macroblocks within the display screen of the remote device.

2. The method of claim 1, wherein the JPEG macroblocks are 16×16 pixel blocks.

3. The method of claim 1, wherein the regions of the display screen requiring updating are non-contiguous.

4. The method of claim 1, wherein the locations of the JPEG macroblocks specified by the positioning metadata are pixel coordinates, the positioning metadata further specifying a number of the JPEG macroblocks to be consecutively located at a set of pixel coordinates.

5. A method of encoding graphical updates to a display screen of a remote device, the method comprising:
determining graphical updates to a display screen of a remote device as corresponding to at least one of a motion-filled area and a static area;
based on a determination that a graphical update corresponds to the motion-filled area, encoding a first pixel block of the graphical update in a first color space in a JPEG image;
based on a determination that a graphical update corresponds to the static area, encoding a second pixel block of the graphical update in a second color space in the JPEG image; and
transmitting the JPEG image to the remote device.

6. The method of claim 5, wherein the first color space is a Y′CbCr color space.

7. The method of claim 5, wherein the second color space is an RGB color space and wherein the pixel block is encoded within the JPEG image as a set of planar pixel blocks corresponding to each color component of the RGB color space.

8. The method of claim 5, further comprising decoding, at the remote device, the JPEG image and storing the decoded JPEG image in both an overlay buffer and a frame buffer, wherein the first pixel block is represented by key color masking in the frame buffer.

9. The method of claim 8, further comprising generating a display signal by retrieving first image data from the frame buffer and second image data from the overlay buffer corresponding to the key color masking in the frame buffer and combining the retrieved first image data and the second image data.

10. The method of claim 5, wherein the first pixel block is a 16×16 pixel block.

11. The method of claim 10, further comprising scaling the first pixel block horizontally by a predetermined factor.

12. The method of claim 5, wherein the second pixel block is an 8×8 pixel block.

13. A system comprising:
a processor configured to identifying regions of a display screen of a remote device requiring updating; and
a graphics encoder configured to:
encode graphical updates of the display screen regions requiring updating as consecutive JPEG macroblocks; and
generate positioning metadata specifying locations of the JPEG macroblocks within the display screen of the remote device; and
a network interface device configured to transmit the encoded graphical updates and the positioning metadata to the remote device.

14. The system of claim 13, wherein the JPEG macroblocks are 16×16 pixel blocks.

15. The system of claim 13, wherein the regions of the display screen requiring updating are non-contiguous.

16. The system of claim 13, wherein the locations of the JPEG macroblocks specified by the positioning metadata are pixel coordinates, the positioning metadata further specifying a number of the JPEG macroblocks to be consecutively located at a set of pixel coordinates.

17. A system comprising:
a processor configured to determine graphical updates to a display screen of a remote device as corresponding to at least one of a motion-filled area and a static area;
a graphics encoder configured to:
encode a first pixel block of the graphical update in a first color space in a JPEG image based on a determination that a graphical update corresponds to the motion-filled area; and
encode a second pixel block of the graphical update in a second color space in the JPEG image based on a determination that a graphical update corresponds to the static area; and
a network interface device configured to transmit the JPEG image to the remote device.

18. The system of claim 17, wherein the first color space is a Y'CbCr color space, and wherein the second color space is an RGB color space and wherein the pixel block is encoded within the JPEG image as a set of planar pixel blocks corresponding to each color component of the RGB color space.

19. The system of claim 17, further comprising decoding, at the remote device, the JPEG image and storing the decoded JPEG image in both an overlay buffer and a frame buffer, wherein the first pixel block is represented by key color masking in the frame buffer.

20. The system of claim 19, further comprising generating a display signal by retrieving first image data from the frame buffer and second image data from the overlay buffer corresponding to the key color masking in the frame buffer and combining the retrieved first image data and the second image data.

21. The system of claim 17, wherein the first pixel block is a 16×16 pixel block.

22. The system of claim 21, further comprising scaling the first pixel block horizontally by a predetermined factor.

23. The system of claim 17, wherein the second pixel block is an 8×8 pixel block.

24. A non-transitory machine-readable medium storing a set of instructions that, when executed by at least one processor, causes the at least one processor to perform operations comprising:
identifying regions of a display screen of a remote device requiring updating;
encoding graphical updates of the display screen regions requiring updating as consecutive JPEG macroblocks; and
transmitting the encoded graphical updates and positioning metadata to the remote device, the positioning metadata specifying locations of the JPEG macroblocks within the display screen of the remote device.

25. The non-transitory machine-readable medium of claim 24, wherein the locations of the JPEG macroblocks specified by the positioning metadata are pixel coordinates, the positioning metadata further specifying a number of the JPEG macroblocks to be consecutively located at a set of pixel coordinates.

26. A non-transitory machine-readable medium storing a set of instructions that, when executed by at least one processor, causes the at least one processor to perform operations comprising:
determining graphical updates to a display screen of a remote device as corresponding to at least one of a motion-filled area and a static area;
based on a determination that a graphical update corresponds to the motion-filled area, encoding a first pixel block of the graphical update in a first color space in a JPEG image;
based on a determination that a graphical update corresponds to the static area, encoding a second pixel block of the graphical update in a second color space in the JPEG image; and
transmitting the JPEG image to the remote device.

27. The non-transitory machine-readable medium of claim 26, wherein the first color space is a Y'CbCr color space, wherein the second color space is an RGB color space, and wherein the pixel block is encoded within the JPEG image as a set of planar pixel blocks corresponding to each color component of the RGB color space.

28. The non-transitory machine-readable medium of claim 26, further comprising decoding, at the remote device, the JPEG image and storing the decoded JPEG image in both an overlay buffer and a frame buffer, wherein the first pixel block is represented by key color masking in the frame buffer.

29. The non-transitory machine-readable medium of claim 28, further comprising generating a display signal by retrieving first image data from the frame buffer and second image data from the overlay buffer corresponding to the key color masking in the frame buffer and combining the retrieved first image data and the second image data.
